(19) United States
(12) Patent Application Publication
(10) Pub. No.: US 2025/0051701 A1
(43) Pub. Date: Feb. 13, 2025

(54) METHOD AND MEANS FOR PROCESSING BEVERAGES

(71) Applicant: STONE TREE INTERNATIONAL LIMITED, London, Greater London (GB)

(72) Inventors: Paul Bertus HAYES, Stellenbosch (ZA); Timothy John BOND, Bedfordshire (GB)

(21) Appl. No.: 18/719,640

(22) PCT Filed: Dec. 9, 2022
(86) PCT No.: PCT/IB2022/061959

§ 371 Date: Jun. 13, 2024

(30) Foreign Application Priority Data
Dec. 14, 2021 (ZA) 2021/10363
Jul. 22, 2022 (ZA) 2022/08186

(51) Int. Cl. C12H 1/00; B65B 3/00; B65B 7/28; B65B 25/00; B65B 55/00; C12G 1/00; C12H 1/14

(52) U.S. Cl. CPC C12H 1/003; B65B 3/00; B65B 7/28; B65B 25/001; B65B 55/00; C12G 1/00; C12H 1/14; C12G 2200/21

(57) ABSTRACT

The invention discloses a method for processing including manufacturing and/or packaging and/or preserving beverages, which includes the step of adding a suitable plant material or plant material blend to a substrate within a vessel so as to mitigate or reduce or prevent the manifestation of a specific beverage impediment. The beverages are non-fermented, or at least partially fermented alcohol, or reductive fermented alcohol (where oxidization during manufacture has been kept to a minimum), or at least partially de-alcoholised. The plant material or plant material blend functions as a biochemical active component and reserve pool (depot) within the beverage or vessel. The invention also discloses an arrangement for the processing and packaging of beverages.

### FIELD OF INVENTION

The present invention relates to a method and means for processing, packaging, storing, and preserving beverages.

More particularly, the present invention relates to an improved method for the manufacture and/or packaging and/or storing and/or preserving of alcoholic and/or other beverages, products produced by such processes, and an improved process for addressing common complications that may arise during- or subsequent to the beverage manufacturing process, including those arising within the packaged format(s) of beverages, notably fermented alcoholic beverages (e.g. wines, beers, ciders) but also in other beverages.

### BACKGROUND TO INVENTION

Tea polyphenols have been shown to have antimicrobial, but notably also deodorizing effects when used in oral preparations, and when compared to other substances (foods which claimed to control halitosis), were found to be superior. The actives within green—as well as black tea (Camellia sinensis), when used in oral preparations shows significant reduction in concentration of both H₂S and CH₃SH gases, thus a number of mouthwashes, toothpastes, breath fresheners include green tea and/or other herbal derivatives to fight halitosis.

Halitosis or “bad breath” is caused mainly by volatile sulphur compounds (VSCs) such as H₂S and CH₃SH produced within the oral cavity. Microorganisms within the mouth degrade proteinaceous substrates to cysteine and methionine, which are then converted to VSCs. In dental care, treatments for halitosis focuses on controlling the number of microorganisms in the oral cavity.

During or following the alcoholic beverage crafting process and/or in bottled (as well as other packaged format) beverages, it is common to encounter “rotten egg” and “cooked/canned vegetable” like aromas or odours. Within the alcoholic beverage crafting industry, these are generally attributed to the type of fermentation process that was undertaken, a so called “reductive approach”, which may result in a beverage that displays above-threshold levels of volatile sulphur compounds (VSC's) or sulphur-like Odours (SLO's); or to other reasons, which may include interaction between beverage, ingredients and/or packaging. The most famous of these odours is hydrogen sulphide (H₂S) that is made by yeasts during fermentation, and it is mainly produced when the yeasts are growing in a nutrient-poor environment or otherwise stressed. Other yeast-derived SLO's include disulphides, thioesters and mercaptans (also known as thiols).

In the beverage industry, including the fermented alcoholic beverage industry, sulphur compounds are commonly used as a preservative. These compounds may be added prior to-, during- and/or following the fermentation process, including at packaging, as the final quality of a beverage at the date of consumption is dependent, amongst others, on the oxidative status at that stage, but also how well the oxidative status had been maintained during the beverage (e.g. wine) making process as well as in packaged format.

Traditionally, sulphur dioxide (also known as SO₂ or ‘sulphite’ in wine maker terms) has been thought of as a relatively innocuous preservative agent, acting mainly as a barrier against oxidation and undesirable bacteria. However, research has shown that SO₂ has an incredibly significant effect on the character of wines, notably in the initial stages of vinification, when it becomes part of numerous reactions and transformations. Sulphur (the “S” in SO₂) is a highly reactive element that enables it to chemically bond to other compounds in many different ways, contributing to the formation of a broad range of (new) molecules.

Sulphur additions is not only limited to preservation during (for example) vinification and up to bottling or packaging but may remain for several years during bottle aging and has a notable impact on wines as they evolve over time, notably at various levels/dosages added during vinification. The chemical composition linked to sulphite additions persists even as wines evolve post bottling. High dosages of sulphites (especially when added early in the winemaking process) do not act as a “reserve pool” or depot to prevent oxidation in the future, but rather creates a weakness and dependence for even more (i.e., higher dosages) of sulphites in order to keep on protecting the constituents within the wines. In addition, a high sulphur dosage is generally associated with allergic reactions or responses in consumers sensitive to sulphites in foods and/or drinks.

Maintaining flavours or aromas which are true to the actual raw material/terroir from which it was made is a significant challenge in winemaking, as well as other beverages. In order to attain this, the traditional view is that sulphites need to be added and other methods employed to limit oxidation. Greater sulphite additions right at the onset of the winemaking process, may favour the presence of thiols. These are sulphur-based compounds that provide aromas like grapefruit and passion fruit in the case of Sauvignon Blanc when wines are made in a very reductive manner, i.e., fermented in stainless steel tanks with extremely limited contact with oxygen. These flavours may be very desirable from a winemaking point of view when trying to achieve this style, but potentially also carries a higher risk of developing SLO's later on. Winemaking and barrel aging with little or no sulphur added on the other hand, will sharply reduce the presence of these thiols, leading to aromas that may be more mineral, citrusy, or tropical.

In the wine industry, reduction reactions are not necessarily all bad. Some important wine aroma compounds are SLO's, e.g., some types of fruity aromas in white wines are polyfunctional thiols; dimethyl sulphide is found in red wine aroma; aromas in traditional method sparkling wines, and also aromas associated with barrel-fermented and aged wines. The balance and concentration of these aromas amongst other volatiles is however the key to when a wine is considered ‘reduced’ and this is seen as a fault.

Managing acetaldehyde formation during winemaking is also a challenge. Acetaldehyde is the most important aldehyde in wine. It is both a precursor to ethanol during fermentation and a product of the oxidation of ethanol. At higher than desirable concentrations, it imparts an unfavourable “bruised apple” flavour/aroma. Excessive acetaldehyde can be formed as a result of an increase in pH and/or poor temperature control during the fermentation process. In addition, yeasts (which usually reduce acetaldehyde to ethanol) may, but under oxidative conditions, oxidise ethanol to acetaldehyde, especially when containers (vats or tanks) are not kept filled or under substantially inert conditions, leading to high acetaldehyde concentrations. Aldehydes and ketones are key SO₂ binding compounds reducing the active ‘free SO₂’ that protects wine. High acetaldehyde concentrations require high S02/sulphite additions, thus exacerbating the situation.

Beverages having a reduced character are not only limited to those found within the winemaking industry, as the phenomenon of a reduced character also occurs in other beverages: non-fermented as well as fermented, such as cider and beer, but also in foodstuffs.

One method to potentially prevent reduction from taking place, is to subject (for instance) the wine during the winemaking process to oxidation, but this in turn could have a detrimental effect on aromas, colour, and general oxidative status.

As previously mentioned, in what is referred to as ‘reductive’ alcoholic beverage fermentation processes, the beverage is processed and fermented in the absence of oxygen. The must is conventionally protected with inert gases (added and/or as a result of fermentation itself) and fermentation undertaken in stainless steel vessels at low temperatures to limit the exposure to oxygen in the making and storage of the beverage. This can result in the preservation of pleasant, “fresh” aromas such as those in a fresh, fruity Sauvignon Blanc, in the case of wine, or fresh fruity flavours in the case of ciders. It is however a very delicate balance not to go too far and create a potential fault in your wine or ciders that could lead to SLO's.

During beverage packaging (e.g., bottling) process, it is generally accepted to be as reductive as possible, i.e., to limit oxygen exposure or sulphite losses, as extraneous oxygen exposure leads to premature aging of (especially) wines and development of unpleasant oxidative characters, including to help preserve colour in red wine or to prevent yellow (oxidised) colours in white wine.

Volatile acidity is a measure of a wine's gaseous acids. The amount of VA in wine is often considered an indicator of spoilage. A wide range of acids contributes to a wine's total VA content, but most winemakers are concerned with acetic acid, which is associated with the smell and taste of vinegar, and ethyl acetate (formed from acetic acid), which causes off-flavours like nail polish or nail polish remover.

Excessive amounts of VA are associated with spoiled/damaged grapes, poor winery or wine-making hygiene, oxidative processes, or a combination thereof. Natural and/or Organic winemaking practices (generally) tend to increase the likelihood of high VA levels in wine when hygiene and oxidation are not substantively addressed—notably as a result of the absence of sulphur as tool to prevent oxidation or to act as preservative.

In red wine cultivars (varietals), harvested grapes have an intrinsic pigment and tannin content or components, termed “phenolic potential.” Only partial extraction of these components happens during the winemaking process and notably, the various components are not all extracted at the same time or rate. Anthocyanins is more water soluble and extracted early in the winemaking process, whilst tannins (which are useful in stabilising the extracted anthocyanins) are more ethanol-soluble and primarily extracted later in the fermentation process. There is thus a mismatch or mis-timing between anthocyanin extraction and sufficient tannins extraction to (naturally) chemically stabilise the extracted anthocyanins, leading to a loss in vibrant red to purple-red colour.

Also, in red wine cultivars (varietals), a substantial amount of the “body” of the wine is directly attributed to the amount of pigment and tannins extracted—ordinarily achieved with robust winemaking techniques, notably period of on-skin extraction/fermentation and pressing regimen thereafter. As a consequence, the wine requires a fining agent to soften or reduce its astringency and/or bitterness. The drawback of fining agents is that they are not selective or discerning in their function, thus they may also remove substantial colour and/or aroma along with astringency.

Effective temperature regulation is of significant importance in the beverage, and also the fermented alcohol industry. It starts with the crafting process of notably white wine, cider, and beer where temperature control is recognised as a critical factor in the production of high-quality final products. Chiller breakdowns or power outages can wreak havoc during the fermentation process.

Another critical phase in temperature regulation is logistics, especially in bulk wine shipments, but also in bulk consumer (“bag in box”) units, both of which are renowned for the propensity of wines deteriorating, due in part to excessive temperatures during shipping from origin to consumer markets where temperatures inside shipping containers may exceed 70° C. for days at a time, but also as a result of SO₂ diffusing or being lost very rapidly through liners and stress cracks in laminates of containers, gaskets or seals used in bulk containers, etc., thus wine is exposed to oxidation and degradation at an increased rate.

Non-food grade materials, notably metals, which may contain iron (Fe), may also lead to oxidation within the beverage crafting industry. Thus, equipment is conventionally manufactured using high grade stainless steel that does not interact with the beverage constituents. Iron contamination may arise from a number of sources and may be completely accidental. In the case of red wine, open concrete tanks or vats are widely used during the initial fermentation and the intrinsic low pH of wine may attack concrete (an inherently basic substance) during use, but especially over time. If present, steel reinforcing, or even metal impurities within the concrete itself may be laid bare, which in turn may trigger a phenolic-ferrous/ferric catalytic reaction initiated by the presence of oxygen, which is a recognised oxidation reaction within alcoholic beverages.

In some instances (concrete) tanks are sealed with an inert food grade liner. The same applies to cases where mild steel storage tanks which (although rarely used nowadays in wineries or other beverage processing facilities) require an intact coating with an inert liner. If the inert liner of a mild steel tank cracks or chips, the contents would come into contact with the steel, potentially triggering a phenolic-ferrous/ferric catalytic reaction, which in turn could lead to oxidation. The same principle may also apply to a packaged beverage within a damaged/impaired metal container, e.g., a can.

Polyphenols within red wine may be able to react with and “neutralise” Fe3⁺ (rust) ions, thereby countering or preventing the phenolic-ferrous reaction. However, the chemical structure when red wine polyphenols react or bind with iron (Fe) is intrinsically weak, thus the reaction may be reversed, re-triggering the phenolic-ferrous/ferric catalytic reaction, leading once more to oxidation. In the case of white wines, there are extremely limited amounts of polyphenols to react with and “neutralise” Fe3⁺ (rust) ions, thus the risk of oxidation is significantly higher.

Oxidation as a result of phenolic-ferrous/ferric catalytic reaction may potentially be countered or masked in the presence of sufficient sulphites. However, there is a significant risk that residual reserves of sulphites may become depleted, leading to faster rates of oxidation.

In contrast to red wine polyphenols, tea (notably EGCG present within green tea) polyphenols comprise of a substantially more potent chemical/molecular structure, and when these polyphenols react with iron (Fe3⁺ or rust) ions, substantially stronger and more stable chemical bonds or structures are formed, thus arresting the phenolic-ferrous/ferric catalytic reaction.

One of the main purposes of beverage enclosures (stoppers or caps), is to protect the beverage inside the packaging, e.g., bottles. Over time, a (cork) stopper loses its key property as an effective seal to protect the bottle's contents from oxidation. Sulphites—due to their volatile nature, may escape past the stoppers, depleting the antioxidant reserves within the wine. This is a significant drawback facing both producers of wine, but also persons wishing to purchase wine for the purpose of maturation and/or investment. Oxidation (in especially older vintages) as a result of stopper failure thus becomes a reality. To combat this threat, stoppers may be replaced (for instance) every 10-20 years, but it is a significant hindrance and also comes at a substantial price.

In addition to conventional corks, novel cork designs have been introduced within the wine industry, which are designed to effortlessly open or uncork bottles. One such (“easy open”) cork design is the Helix™, manufactured by Amorim Cork in Portugal, which is used in combination with specially manufactured bottles by Owens Illinois of the United States of America. These corks are shorter than conventional corks and (may also) contain grooves in the cork, which are meant to fit inside the ridges on the interior of the neck of the bottle. This design is however imperfect as far as that it actually may contribute or create a path for free SO₂ to escape easier along the grooves of the stopper, thus the wine inside may be predisposed to substantially higher incidence of oxidation when compared to conventional stoppers, thus leading to faster rates of degradation and lower quality wine.

Another type of stopper in especially the wine industry, is the mechanical tap/faucet used in bulk consumer packaging, so called Bag-in-Box (BIB) type packaging. This design is also imperfect as far as that it may allow air to enter into the bag (bladder) of the box, thus the contents (e.g., wine) inside may be predisposed to substantially higher incidence of oxidation when compared to unopened wine. In addition, sulphites added as antioxidant/preservative may migrate within a relatively brief period of time (a few weeks to months) through the packaging material, especially at higher temperatures and when utilising thinner or lower quality packaging material, leading to lower quality wine as a result of oxidation or loss of sulphites, a substantially shorter shelf life when compared to bottled beverages.

Fruit and vegetable substrates and the fermented beverages manufactured from these (e.g., wine, cider, beer) are complex matrices of different chemical species including carbohydrates, alcohols, phenolics, and aroma molecules from numerous classes. The classes of phenolics in particular include a wide range of structures including both flavonoid (anthocyanins (colour), condensed tannins (body)) as well as non-flavonoid moieties. The species and concentrations are a result of raw materials as well as processing. In many cases other species/classes with superior properties as anti-oxidants, in sulphur-capture/SLO reduction and colour stabilisation are not present naturally in significant quantities, thus natural additives/processing aids providing useful properties in improving/maintaining fermented beverage quality are required. Not all these beneficial compounds/actions might be found in a single plant and thus blends of plant materials may be superior to a single species.

It is an object of this invention to suggest a method of processing alcoholic- or other beverages and/or of packaging alcoholic- or other beverages, where a natural plant material additive may act at a biochemical level within the beverage when added at various stages of beverage manufacture and/or at packaging, including incorporation within packaging material, to mitigate, reduce or prevent the manifestation of sulphur like Odours (SLO's) or “Reduction” reactions within alcoholic- or other beverages.

It is also an object of this invention to suggest a method of processing alcoholic- or other beverages and/or of packaging alcoholic- or other beverages, where a natural plant material additive may act as a non-volatile “reserve pool” or depot when added at various stages of beverage manufacture and/or at packaging, including incorporation within packaging material, to mitigate, reduce or prevent oxidation in future in order to keep on protecting the constituents within the alcoholic- or other beverages beverage.

It is also an object of this invention to suggest a method of processing alcoholic- or other beverages and/or of packaging alcoholic- or other beverages, where a natural plant material additive may act at a biochemical level within the beverage when added at various stages of beverage manufacture and/or at packaging, including incorporation within packaging material, to mitigate, reduce or prevent the manifestation of discoloration or sudden oxidation, so called “Pinking” in white wines.

It is also an object of this invention to suggest a method of processing alcoholic- or other beverages and/or of packaging alcoholic- or other beverages, where a natural plant material additive may act at a biochemical level within the beverage when added at various stages of beverage manufacture and/or at packaging, including incorporation within packaging material, to mitigate, reduce or prevent the manifestation of taints and off flavours as indicators of poor quality such as Volatile Acidity (VA) and Acetaldehyde formation.

It is also an object of this invention to suggest a method of processing alcoholic- or other beverages and/or of packaging alcoholic- or other beverages, where a natural plant material additive may act at a biochemical level within the beverage when added at various stages of beverage manufacture and/or at packaging, including incorporation within packaging material, to mitigate, reduce or prevent quality deteriorations as a result of excessive or imperfect temperature or other non-ideal conditions (including design or operational shortcomings) during manufacture, and notably during storage and transport of bulk volume product, bulk consumer units or within final packaged units.

It is also an object of this invention to suggest a method of processing alcoholic- or other beverages and/or of packaging alcoholic- or other beverages, where a natural plant material additive may act at a biochemical level within the beverage when added at various stages of beverage manufacture and/or at packaging, including incorporation within packaging material, to mitigate, reduce or prevent phenolic-ferrous/ferric or other adverse interactions or reactions between or within beverage, constituents and/or packaging material.

It is also an object of this invention to suggest a natural plant material additive which acts on a biochemical level as a “fining agent” to remove primarily or selectively the molecules or constituents responsible for excessive astringency, formation of sediment(s) in the bottom or sides of bottled beverages when added to fermented alcoholic beverages to mitigate, reduce or prevent shortcomings of fining agents on colour, taste, mouthfeel and/or aroma removal.

It is also an object of this invention to suggest a natural plant material additive which acts on a biochemical level when added to fermented alcoholic beverages or which may be added to or incorporated within packaging material to mitigate, reduce, or prevent the manifestation of colour fallout or precipitation in red wine due to an imbalance in Phenolic Potential.

It is also an object of this invention to suggest a method of processing alcoholic- or other beverages and/or of packaging alcoholic- or other beverages, where a natural plant material additive may act at a biochemical level within the beverage when added at various stages of beverage manufacture and/or at packaging, including incorporation within packaging material, to mitigate, reduce or prevent microbial growth of bacteria and/or yeast.

It is also an object of this invention to suggest a natural plant material additive which acts on a biochemical level when added to beverages, including fermented alcoholic beverages or which may be added to or incorporated within packaging material including screw caps, conventional- and/or “easy open”, e.g. Helix™ (cork) stoppers to assist in the longevity, maturation and/or preservation of beverages.

It is also an object of this invention to suggest a natural plant material additive which acts on a biochemical level when added to beverages, including fermented alcoholic beverages or which may be added to or incorporated within packaging material including stopper(s) conventionally utilised for bulk consumer “Bag-in-Box (BIB)” packaged beverages to assist in the longevity, maturation and/or preservation of bulk consumer “Bag-in-Box (BIB)” packaged beverages.

It is also an object of this invention to suggest a method for the manufacture and/or use of packaging material and/or enclosures (stopper(s)), including containers, screw caps, conventional- and/or “easy open” Helix™ (cork) stoppers, taps/faucets for bulk consumer “Bag-in-Box (BIB)” type packaged beverages as dispensing and/or dosing means to deliver natural plant material additive in order to protect beverages (including alcoholic) beverages within a packaged format as depicted within this invention.

It is also an object of this invention to suggest an efficacious dosage or inclusion rate of the completely natural plant material additive in accordance with this invention.

Please note that in this invention, the method, means and/or specific descriptions and/or embodiments/examples should not be construed as being limited to that specific beverage, type, or class of beverage, but to all beverages (alcoholic and/or non-alcoholic) where this invention may be successfully applied. In addition, this invention, the method, means and/or specific descriptions and/or embodiments should not be construed as being limited to the examples set out for packaging material, method or stopper described, but to packaging materials, methods, or stoppers in general where this invention may be successfully applied. It should further be noted that this invention is equally applicable to the processing of a range of (packaged) foodstuffs (i.e., not beverages per se) where sufficient moisture may be present (or which could be added) in order to ensure efficacy of this invention in use with applicable foodstuff(s).

### SUMMARY OF INVENTION

According to the invention, a method for processing beverages includes the step of adding suitable plant material or plant material blend to a substrate within a vessel so as to mitigate or reduce or prevent the manifestation of a specific beverage impediment.

The processing may include manufacturing and/or packaging and/or preserving.

The beverage may be non-fermented, or at least partially fermented alcohol, or reductive fermented alcohol (where oxidization during manufacture has been kept to a minimum), or at least partially de-alcoholised.

The plant material or plant material blend may function as biochemical active component and reserve pool” (depot) within the beverage or vessel.

The plant material or plant material blend may contain flavonoids.

The flavonoids may be flavanols and/or flavones.

The flavanols may be catechins (including epi-catechins) or gallocatechins.

The flavonols may be quercetin, hyperoxide, isoquercetin or rutin.

The flavones may be orientin, iso-orientin or vitexin.

The flavonoids may be flavonols.

The plant material or plant material blend may contain polyphenol esters and/or caffeic acid esters.

The polyphenol ester may be chlorogenic acid.

The caffeic acid ester may be rosmarinic acid.

The plant material or plant material blend may be in a non-aerated or non-oxidised processing state (i.e., “green”) and may comprise of at least one of the plant families of Theaceae and/or Aquifoliaceae and/or Rubiaceae and/or Fabaceae and/or Malvaceae and/or Juglandaceae and/or Lamiaceae.

The plant material or plant material blend may be at least partially aerated and may comprise of at least one of the plant families Theaceae and/or Aquifoliaceae and/or Rubiaceae and/or Fabaceae and/or Malvaceae and/or Juglandaceae and/or Lamiaceae.

The plant material or plant material blend may be processed into a comminute, extract, derivative (including synthesized) or infusion and may be altered to increase or decrease biochemical components.

The substrate may be water, derived from fruit and/or vegetable and/or grain and/or other carbohydrate, fresh, in-process, or processed, including at least partially fermented or de-alcoholised.

The vessel may be a container for combining plant material with substrate, for primary beverage manufacture (e.g., tank or vat), for bulk storage and/or transportation purposes, or packaging for consumer use.

The packaging may include an enclosure: cap or stopper or tap (faucet), bulk consumer packaging (“Bag-in-Box”) and may be modified to receive plant material or plant material blend.

The specific beverage impediment may be sulphur like odours (SLO's), also known as volatile sulphur compounds (VSC's), or similar taints.

The specific beverage impediment may be volatile acidity (VA).

The specific beverage impediment may be high acetaldehyde formation.

The specific beverage impediment may be microbial growth and/or spoilage.

The specific beverage impediment may be quality deterioration as a result of poor or imperfect temperature or other non-ideal conditions during manufacture, bulk storage or transport units, or within bulk consumer (Bag-in-Box) units that may be attributed to permeable or semi-permeable packaging/materials of assembly, excessive- or fluctuation in temperature, stress cracks, design or operational shortcomings and/or period of use.

The specific beverage impediment may be oxidation or chemical change as a result of phenolic-ferrous/ferric or other chemical interactions between or within beverage, constituents and/or packaging material.

The specific beverage impediment may be quality deterioration as a result of the use of a fining agent(s).

The quality deterioration may be higher levels of oxidation and/or discoloration and/or loss of colour and/or loss of freshness and/or fruitiness in aromas and/or loss in mouthfeel and/or manifestation of a taint or “off taste” and/or colour fallout or precipitation in red wine due to an imbalance in Phenolic Potential.

The specific beverage impediment may be oxidation as a result of loss of volatile preservative (S02) within corked beverages using conventional corks or “easy open corks” e.g., Helix™ corks or through bulk consumer (Bag-in-Box) packaging (liners).

The specific beverage impediment may be an allergic response.

Also, according to the invention, an arrangement for the processing of beverage, includes a vessel to combine suitable plant material with substrate; processing means to process substrate into beverage; plant material or plant material blend supply means, and substrate supply means to move plant material or plant material blend and substrate into the vessel.

The vessel may be a bulk container used in primary manufacture and/or storage, e.g., tank or vat.

The vessel may be a pipe.

The vessel and/or plant material supply means and/or substrate supply means may be substantially combined.

The vessel may be a container used for intermediary storage e.g., bulk wine container, tote, etc.

The vessel may be bulk consumer packaging, i.e., Bag-in-Box packaging.

The vessel may be a container used for final (retail) packaging or storage, e.g., bottle, “Tetra-pack,” can, foil- and/or plastic bag etc.

The vessel may be a specialised container (bottle) containing grooves or ridges.

The vessel may include an enclosure (cap or stopper) designed to seal the container.

The vessel and/or enclosure may be modified to accept plant material or plant material blend.

The processing means may include conventional equipment used within the beverage and also the fermented alcohol beverage industries, e.g. pumps, mixers, chillers, filtration, filling and packaging, alcohol standardisation or removal means to add- or remove alcohol to render fortified, low alcohol or alcohol free beverage, as well as specialised manufacturing and/or dispensing means for distributing plant material or plant material blend into or onto/within the vessel (including packaging material).

The preferred dosage of flavonoids and/or polyphenol esters and/or caffeic acid esters from plant material or plant material blend, including derivative, may be between 1 mg and 5000 mg per litre at final beverage dilution as measured using the Folin-Ciocalteu (“F-C”) method.

A more preferred dosage of flavonoids and/or polyphenol esters and/or caffeic acid esters from plant material or plant material blend, including derivative, may be between 25 mg and 1000 mg per litre at final beverage dilution as measured using the Folin-Ciocalteu (“F-C”) method.

### DETAILED DESCRIPTION OF INVENTION

The invention will now be described by way of example.

According to the invention, a method for processing beverages, which includes the step of adding a suitable plant material or plant material blend to a substrate within a vessel so as to mitigate or reduce or prevent the manifestation of a specific beverage impediment.

The processing is manufacturing and/or packaging and/or preserving.

The beverages are non-fermented, or at least partially fermented alcohol, or reductive fermented alcohol (where oxidization during manufacture has been kept to a minimum), or at least partially de-alcoholised.

The plant material or plant material blend functions as a biochemical active component and reserve pool (depot) within the beverage or vessel.

The plant material or plant material blend contains flavonoids.

The flavonoids are flavanols and/or flavones and/or flavonols.

The flavanols are catechins, epi-catechins and/or gallocatechins, the flavonols are quercetin, hyperoxide, isoquercetin and/or rutin, and/or the flavones are orientin, iso-orientin and/or vitexin.

The plant material or plant material blend contains polyphenol esters and/or caffeic acid esters.

The polyphenol ester is chlorogenic acid.

The caffeic acid ester is rosmarinic acid.

The plant material or plant material blend contain alkaloids and/or caffeine.

The plant material or plant material blend are in a non-aerated or non-oxidised processing state (i.e., “green”) and comprise of at least one of the plant families Theaceae and/or Aquifoliaceae and/or Rubiaceae and/or Fabaceae and/or Malvaceae and/or Juglandaceae and/or Lamiaceae.

The plant material or plant material blend are at least partially aerated and comprise of at least one of the plant families Theaceae and/or Aquifoliaceae and/or Rubiaceae and/or Fabaceae and/or Malvaceae and/or Juglandaceae and/or Lamiaceae.

The plant material or plant material blend are processed into a comminute, extract, derivative (including synthesized) or infusion and are altered to increase or decrease biochemical components.

The substrate is water, derived from fruit and/or vegetable and/or grain and/or other carbohydrate, fresh, in-process, or processed, including at least partially fermented or de-alcoholised.

The vessel is a container for combining plant material with substrate, for primary beverage manufacture (e.g., tank or vat), for bulk storage and/or transportation purposes, or packaging for consumer use and/or packaging having an enclosure, cap or stopper or tap (faucet), bulk consumer packaging (“Bag-in-Box”) and/or be modified to receive plant material or plant material blend.

The specific beverage impediment is at least one selected from the group consisting of: sulphur like odours (SLO's), also known as volatile sulphur compounds (VSC's), or similar taints; volatile acidity (VA); high acetaldehyde formation; microbial growth; spoilage; quality deterioration as a result of poor or imperfect temperature or other non-ideal conditions during manufacture, bulk storage or transport units, or within bulk consumer (Bag-in-Box) units that are attributed to permeable or semi-permeable packaging/materials of assembly, excessive—or fluctuation in temperature, stress cracks, design or operational shortcomings and/or period of use; oxidation or chemical change as a result of phenolic-ferrous/ferric or other chemical interactions between or within beverage, constituents and/or packaging material; quality deterioration as a result of the use of a fining agent(s); quality deterioration as a result of higher levels of oxidation and/or discoloration and/or loss of colour and/or loss of freshness and/or fruitiness in aromas and/or loss in mouthfeel and/or manifestation of a taint or “off taste” and/or colour fallout or precipitation in red wine due to an imbalance in Phenolic Potential; oxidation as a result of loss of volatile preservative (SO2) within corked beverages using conventional corks or “easy open corks” or through bulk consumer (Bag-in-Box) packaging (liners); an allergic response.

Also according to the invention, an arrangement for the processing of beverages, includes
(a) a vessel to combine suitable plant material with a substrate;
(b) processing means to process the substrate into a beverage;
(c) plant material or plant material blend supply means; and
(d) a substrate supply means to move plant material or plant material blend and substrate into the vessel.

The vessel is a bulk container used in primary manufacture and/or storage, e.g., tank or vat.

The vessel is at least one selected from the group comprising: a pipe; a container used for intermediary storage e.g., bulk wine container, tote, etc.; bulk consumer packaging, i.e., Bag-in-Box packaging; a container used for final (retail) packaging or storage, e.g., bottle, “Tetra-pack,” can, foil- and/or plastic bag etc.; a specialised container (bottle) containing grooves or ridges.

The vessel includes an enclosure (cap or stopper) designed to seal the container and/or in which the vessel and/or enclosure are modified to accept plant material or plant material blend.

The processing means include conventional equipment used within the beverage and also the fermented alcohol beverage industries, e.g. pumps, mixers, chillers, filtration, filling and packaging, alcohol standardisation or removal means to add- or remove alcohol to render fortified, low alcohol or alcohol free beverage, as well as specialised manufacturing and/or dispensing means for distributing plant material or plant material blend into or onto/within the vessel (including packaging material).

The preferred dosage of flavonoids and/or polyphenol esters and/or caffeic acid esters from plant material or plant material blend, including derivative, is between 1 mg and 5000 mg per litre at final beverage dilution as measured using the Folin-Ciocalteu (“F-C”) method.

The preferred dosage of flavonoids and/or polyphenol esters and/or caffeic acid esters from plant material or plant material blend, including derivative, is between 25 mg and 1000 mg per litre at final beverage dilution as measured using the Folin-Ciocalteu (“F-C”) method.

The vessel and/or plant material supply means and/or substrate supply means are substantially combined.

The invention will now be depicted by way of a number of embodiments:

In a first embodiment of this invention, finely milled, non-fermented plant material of the plant families Aquifoliaceae and Theaceae at a dosage of 750 mg per litre is added to sauvignon blanc must at the onset of fermentation in a stainless-steel tank. Conventional wine making methods are followed, but no additional sulphites are added throughout, and processing is undertaken at low pH range to minimise the risk of microbial spoilage. Wine is made in a very reductive manner by using C02 as an inert gas to substantially prevent oxidization throughout processing. Following fermentation, the wine is (sterile) filtered and bottled, also under reductive conditions. Six months post bottling, the wine is assessed and boasts a natural, fresh flavour with no SLO/‘reduction’-characteristics or discoloration (“pinking”) when opened, with the benefit of being sulphite-free, thus not causing a sulphite-related allergic response.

In a second embodiment of this invention, 10 ml of a sterile filtered, water-based plant material extract at a concentration level of 10 brix (percent solids), which has been extracted from non-fermented plant material of the plant families Aquifoliaceae and Theacea, is added (dosed in-line via a dosing pump) to every 3 liter volume of dry, white wine blend packaged in “bag-in-box” bulk consumer units at point of packaging. Six months post packaging, the wine is assessed and compared to a control. Laboratory analysis for residual sulphites indicate equally low levels in both products, indicating loss through packaging material. However, the treated wine has a more fruity and fresher flavour than the control, indicating better protection of the contents in comparison to untreated wine within BIB packaging.

In a third embodiment of this invention, 225 mg of water-soluble spray dried extract of non-fermented plant materials of the plant families Aquifoliaceae and Theacea, is combined and pressed into a small pellet (tablet). An “easy open” Helix™ cork stopper is modified in order to accept and deliver the tablet during/post bottling into 750 ml of dry red wine. The wine, together with a conventional “easy open” Helix™ corked wine (control) is subjected to accelerated storage which is the equivalent of 36 months. In comparison, the treated wine has better aroma and taste profile than the control, indicating superior protection by the treatment.

In a fourth embodiment of this invention, 180 mg of water-soluble spray dried extract of non-fermented plant material of the plant families Aquifoliaceae and Theacea, is incorporated as a flat disc within the inner liner of screw caps for 750 ml bottles of white wines. The liner is designed to release plant material into the contents of the white wine, which had been made in a very reductive style, to reduce the incidence of “pinking.”

In a fifth embodiment of this invention, 1500 mg of spray dried soluble extract of the plant families Aquifoliaceae and Theacea, is pressed into a tablet, which is placed inside a plastic expansive mesh receptacle, which fits securely within the cavity of the tap (faucet) mechanism of a 5 liter red wine “bag-in-box” bulk consumer unit. The expansive mesh receptacle is constructed so as to allow easy solubilisation of the tablet into the beverage, whilst not impeding with any beverage flow through it when decanting. The plant material tablet is designed to dissolve completely within hours following interaction with the beverage. Six months post packaging, the wine is assessed and compared to a control. Laboratory analysis for residual sulphites indicate equally low levels in both products, indicating loss thereof through packaging material. However, the treated wine has a better taste than the control, indicating better protection of the contents from degradation/oxidation in comparison to untreated wine within BIB packaging.

In a sixth embodiment of this invention, the equivalent of 1500 mg (on a dried basis) of soluble extract of the plant families Aquifoliaceae and Theacea (as per 5^{th} embodiment) is incorporated into/onto the interior of the liner of a 5 litre red wine “bag-in-box” bulk consumer unit to render an “active” packaging designed to dissolve completely within the beverage thereby offering better protection of the contents from degradation/oxidation in comparison to untreated wine within BIB packaging.

1.-26. (canceled)

27. A method for processing beverages, which includes the step of adding a suitable plant material or plant material blend to a substrate within a vessel so as to mitigate or reduce or prevent the manifestation of a specific beverage impediment.

28. The method as claimed in claim 27, in which the processing is manufacturing and/or packaging and/or preserving.

29. The method as claimed in claim 27, in which the beverages are non-fermented, or at least partially fermented alcohol, or reductive fermented alcohol (where oxidization during manufacture has been kept to a minimum), or at least partially de-alcoholised.

30. The method as claimed in claim 27, in which the plant material or plant material blend functions as a biochemical active component and reserve pool (depot) within the beverage or vessel.

31. The method as claimed in claim 27, in which the plant material or plant material blend contains flavonoids.

32. The method as claimed in claim 31, in which the flavonoids are flavanols and/or flavones and/or flavonols.

33. The method as claimed in claim 32, in which the flavanols are catechins, epi-catechins and/or gallocatechins, the flavonols are quercetin, hyperoxide, isoquercetin and/or rutin, and/or the flavones are orientin, iso-orientin and/or vitexin.

34. The method as claimed in claim 27, in which the plant material or plant material blend contains polyphenol esters and/or caffeic acid esters.

35. The method as claimed in claim 34, in which the polyphenol ester is chlorogenic acids and the caffeic acid ester is rosmarinic acid.

36. The method as claimed in claim 27, in which the plant material or plant material blend are in a non-aerated or non-oxidised processing state (i.e., “green”) or are at least partially aerated, and comprise of at least one of the plant families Theaceae and/or Aquifoliaceae and/or Rubiaceae and/or Fabaceae and/or Malvaceae and/or Juglandaceae and/or Lamiaceae.

37. The method as claimed in claim 27, in which the plant material or plant material blend are processed into a comminute, extract, derivative or infusion and are altered to increase or decrease biochemical components.

38. The method as claimed in claim 27, in which the substrate is water, derived from fruit and/or vegetable and/or grain and/or other carbohydrate, fresh, in-process, or processed, including at least partially fermented or de-alcoholised.

39. The method as claimed in claim 27, in which the vessel is a bulk container used in primary manufacture and/or storage, e.g., tank or vat and/or a container for combining plant material with substrate, for primary beverage manufacture (e.g., tank or vat), for bulk storage and/or transportation purposes, or packaging for consumer use and/or packaging having an enclosure, cap or stopper or tap (faucet), bulk consumer packaging (“Bag-in-Box”) and/or be modified to receive plant material or plant material blend.

40. The method as claimed in claim 27, in which the specific beverage impediment is at least one selected from the group consisting of: sulphur like odours (SLO's), also known as volatile sulphur compounds (VSC's), or similar taints; volatile acidity (VA); high acetaldehyde formation; microbial growth; spoilage; quality deterioration as a result of poor or imperfect temperature or other non-ideal conditions during manufacture, bulk storage or transport units, or within bulk consumer (Bag-in-Box) units that are attributed to permeable or semi-permeable packaging/materials of assembly, excessive—or fluctuation in temperature, stress cracks, design or operational shortcomings and/or period of use; oxidation or chemical change as a result of phenolic-ferrous/ferric or other chemical interactions between or within beverage, constituents and/or packaging material; quality deterioration as a result of the use of a fining agent(s); quality deterioration as a result of higher levels of oxidation and/or discoloration and/or loss of colour and/or loss of freshness and/or fruitiness in aromas and/or loss in mouthfeel and/or manifestation of a taint or “off taste” and/or colour fallout or precipitation in red wine due to an imbalance in Phenolic Potential; oxidation as a result of loss of volatile preservative (SO₂) within corked beverages using conventional corks or “easy open corks” or through bulk consumer (Bag-in-Box) packaging (liners); an allergic response.

41. An arrangement for the processing of beverages, which includes
(a) a vessel to combine suitable plant material with a substrate;
(b) processing means to process the substrate into a beverage;
(c) plant material or plant material blend supply means; and
(d) a substrate supply means to move plant material or plant material blend and substrate into the vessel.

42. The arrangement as claimed in claim 41, in which the vessel is at least one selected from the group comprising: a pipe; a container used for intermediary storage e.g., bulk wine container, tote, etc.; bulk consumer packaging, i.e., Bag-in-Box packaging; a container used for final (retail) packaging or storage, e.g., bottle, “Tetra-pack,” can, foil- and/or plastic bag etc.; a specialised container (bottle) containing grooves or ridges.

43. The arrangement as claimed in claim 41, in which the vessel includes an enclosure (cap or stopper) designed to seal the container and/or in which the vessel and/or enclosure are modified to accept plant material or plant material blend.

44. The arrangement as claimed in claim 41, in which the processing means include conventional equipment used within the beverage and also the fermented alcohol beverage industries, e.g. pumps, mixers, chillers, filtration, filling and packaging, alcohol standardisation or removal means to add- or remove alcohol to render fortified, low alcohol or alcohol free beverage, as well as specialised manufacturing and/or dispensing means for distributing plant material or plant material blend into or onto/within the vessel (including packaging material).

45. The arrangement as claimed in claim 41, in which the preferred dosage of flavonoids and/or polyphenol esters and/or caffeic acid esters from plant material or plant material blend, including derivative, is between 1 mg and 5000 mg or between 25 mg and 1000 mg per litre at final beverage dilution as measured using the Folin-Ciocalteu (“F-C”) method.

46. The arrangement as claimed in claim 41, in which the vessel and/or plant material supply means and/or substrate supply means are substantially combined.
